(19) United States
(12) Patent Application Publication
(10) Pub. No.: US 2023/0151593 A1
(43) Pub. Date: May 18, 2023

(54) FAUCET AND SPOUT THEREOF

(71) Applicants: Miaoyun Huang, Visalia, CA (US); DAWNWAY ENTERPRISE CO., LTD., Taichung City (TW)

(72) Inventor: Wen-Shun Huang, Taichung City (TW)

(21) Appl. No.: 17/987,643

(22) Filed: Nov. 15, 2022

(30) Foreign Application Priority Data
Nov. 15, 2021 (TW) 110142458

(51) Int. Cl. E03C 1/04; B05B 7/08

(52) U.S. Cl. CPC E03C 1/0404; B05B 7/0846

(57) ABSTRACT

A faucet includes a base, two water controllers disposed on the base, an outer tube connected to the base, an inner tube disposed within the outer tube, and a spout. The spout has a first channel that is only in communication with the outer tube, a second channel that is only in communication with the inner tube, and a spacer portion separating the first and second channels by a certain distance.

### BACKGROUND OF INVENTION

### 1. Field of Invention

The present invention relates to a faucet and, more particularly, to a faucet and a spout for a drinking water dispenser.

### 2. Related Prior Art

Conventional under-cabinet drinking water supply system typically includes a cold and hot faucet (such as disclosed in Taiwan Patent I316595), a filter device (such as a water purifier or a R.O. pure water machine) and an instant hot water dispenser. The structures of cold and hot faucet are disclosed in Taiwan Patent M536304, M391016, M242621, and M247742, wherein, the hot and cold faucet includes a base, an outer tube connected to the base, an inner tube disposed in the outer tube and two discharge controllers for controlling the outer tube and the inner tube respectively.

The two discharge controllers respectively control the discharging of hot water and cold water. When hot water discharge controller is turned on, cold water filtered by the filter device is introduced into the base and then enters into a hot water tank of the instant hot water dispenser so that hot water in the tank is discharged from the inner tube till hot water discharge controller is turned off. On the other hand, when cold water discharge controller is turned on, cold water is introduced into the base and then is discharged from the outer tube till cold water discharge controller is turned off.

The tank of the instant hot water dispenser usually connects with an expansion chamber and a Venturi effect orifice block which are disclosed in U.S. Pat. No. 6,847,782, also disclosed in Taiwan Patent I632334, I532959B and I384191. With the function of the Venturi effect orifice block, the expansion chamber sucks a little water back into the tank right after the hot water discharge controller is turned off. According to this, hot water in the inner tube returns so as to avoid leaking.

However, in a specific case that the cold water discharge controller is turned on right after the hot water discharge controller is turned off, cold water discharged from the outer tube will be sucked into the inner tube because cold water is too close to the inner tube. The expansion chamber, therefore, is filled with water, and then the suction ability is lowered or lost so that hot water leaks again.

### SUMMARY OF INVENTION

It is the primary objective of the present invention to provide a faucet and a spout thereof to solve the above-mentioned problem.

To achieve the foregoing objective, the present invention provides a faucet including a base introducing hot water and cold water, an outer tube for cold water to flow through, an inner tube for hot water to flow through, a cold water discharge controller determining whether cold water flows out of the outer tube, a hot water discharge controller determining whether hot water flows out of the inner tube, and a spout. The outer tube includes an outer tube inlet connected to the base and an outer tube outlet in communication with the outer tube inlet. The inner tube is disposed within the outer tube and includes an inner tube inlet connected to the base and an inner tube outlet in communication with the inner tube inlet. Both the cold water discharge controller and the hot water discharge controller are disposed in the base. The spout includes an upper portion connected to the outer tube outlet and a lower portion extending downward from the upper portion. The lower portion has a first channel that is only in communication with the outer tube, a second channel that is only in communication with the inner tube, and a spacer portion separating the first and second channels.

In one embodiment, both the first and second channels extend vertically. Or in another embodiment, both the first and second channels extend obliquely. Or in another embodiment, one of the first and second channels extends vertically, while the other extends obliquely.

Furthermore, the upper portion of the spout has a slot receiving the outer tube outlet. The lower portion of the spout has an enlarged space with an inner diameter greater than that of the slot. The enlarged space is in communication with the slot. The enlarged space connects with an upper opening of the first channel. The inner tube outlet passes through the enlarged space and is connected to an upper groove of the second channel.

A hollow connector and an O-ring are provided at the inner tube outlet. The hollow connector includes a first section and a second section having a greater diameter than the first section. The first section is engaged in the inner tube outlet. The second section is engaged in the upper groove. The O-ring is tightly engaged with the second section and the upper groove.

The present invention further provides a spout of a faucet including an upper portion and a lower portion extending downward from the upper portion. The upper portion has a slot. The lower portion includes a first channel and a second channel that are in communication with the slot, and a spacer portion separating the first and second channels.

In one embodiment, both the first and second channels extend vertically. Or in another embodiment, both the first and second channels extend obliquely. Or in another embodiment, one of the first and second channels extends vertically, while the other extends obliquely.

Furthermore, the lower portion has an enlarged space with an inner diameter greater than that of the slot. The enlarged space is in communication with the slot. The enlarged space is in communication with an upper opening of the first channel. The enlarged space is in communication with an upper groove of the second channel.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of the present invention;

FIG. 2 is a perspective exploded view of the present invention;

FIG. 3 is a cross-sectional view of the tubes and the spout which are disassembled;

FIG. 4 is a cross-sectional view of the tubes and the spout which are assembled;

FIGS. 5(a) to 5(c) illustrate cross-sectional views of various spouts in the present invention.

### DETAILED DESCRIPTION OF PREFERRED EMBODIMENT

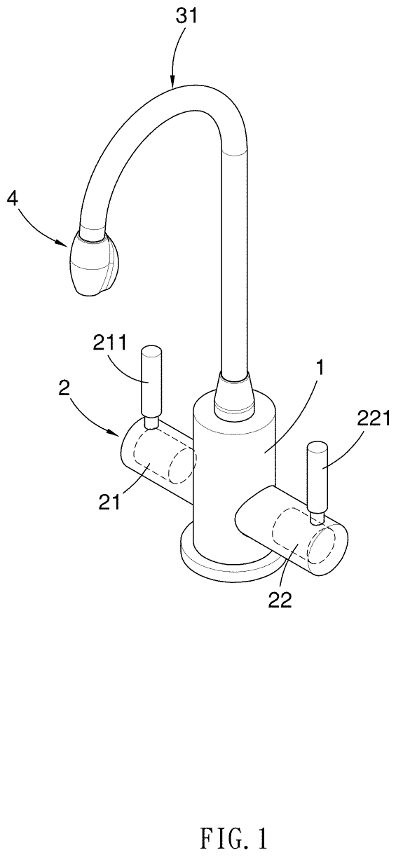

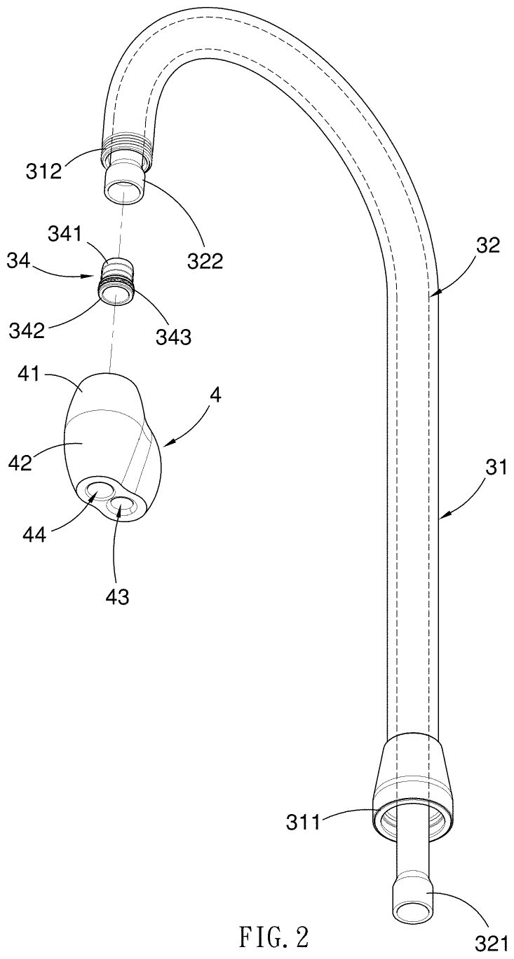

FIGS. 1 and 2 show a preferred embodiment of a faucet of the present invention including a base 1, a cold water discharge controller 21, a hot water discharge controller 22, an outer tube 31, an inner tube 32 and a spout 4.

The base 1 is provided with appropriate channels (not shown in the figures) for introducing cold water into the outer tube 31 and introducing hot water into the inner tube 32. In a case that the base 1 is connected to a drinking water dispenser with an expansion chamber and a Venturi effect orifice block, such as disclosed in U.S. Pat. No. 6,847,782, cold water filtered by a filter is controlled by the cold water discharge controller 21 to be discharged via the outer tube 31 while hot water heated by a heater is controlled by the hot water discharge controller 22 to be discharged via the inner tube 32.

The cold and hot water discharge controllers 21, 22 are both disposed in the base 1. In this embodiment, mechanical controllers driven by handles are used. A cold water switch handle 211 is configured to control cold water to be discharged via the outer tube 31, and a hot water switch handle 221 is configured to control hot water to be discharged via the inner tube 32. However, electrical controllers with touch or infrared sensor may be used.

The outer tube 31 has an outer tube inlet 311 and an outer tube outlet 312 in communication with the outer tube inlet 311. The outer tube inlet 311 is connected to the base 1 for cold water to pass through. The inner tube 32 is disposed within the outer tube 31 and has an inner tube inlet 321 and an inner tube outlet 322 in communication with the inner tube inlet 321. The inner tube inlet 321 is connected to the base 1 for hot water to pass through. In this embodiment, the outer tube 31 is a hard metal tube made of copper or stainless steel while the inner tube 32 is a soft tube made of plastic, rubber or silicone. However, the inner tube 32 may be harder than the above-mentioned soft tubes.

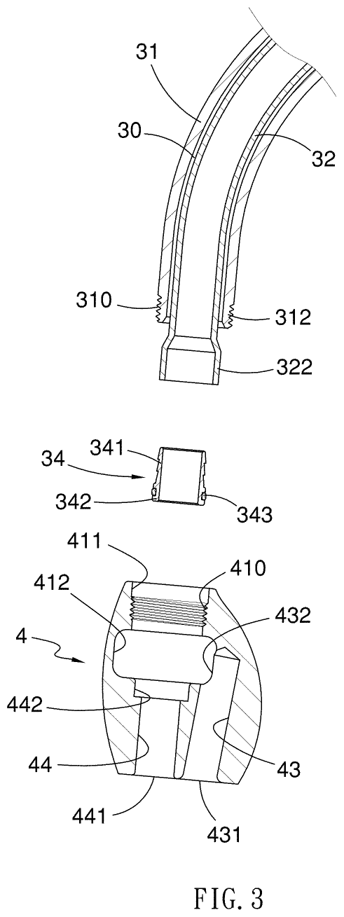

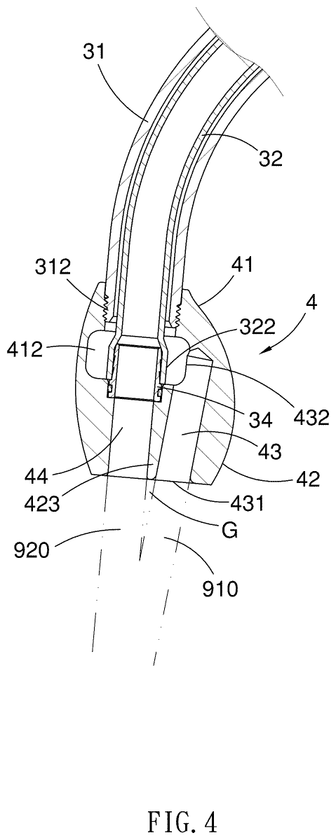

As shown in FIGS. 3 and 4, the spout includes an upper portion 41 and a lower portion 42 extending downward from the upper portion 41.

The upper portion 41 is connected to the outer tube outlet 312. The lower portion 42 including a first channel 43, a second channel 44 and a spacer portion 423. The first channel 43 is only in communication with the outer tube 31 via the outer tube outlet 312. The second channel 44 is only in communication with the inner tube 32 via the inner tube outlet 322. The spacer portion 423 separates the first channel 43 and the second channel 44 to ensure independence therebetween.

In a case that the hot water discharge controller 22 is turned on, hot water 920 introduced by the base 1 passes through the inner tube 32 and the second channel 44, and then flows out of the spout 4. Conversely, the hot water 920 is stopped from being discharged. In a case that the cold water discharge controller 21 is turned on, cold water 910 introduced by the base 1 passes through the outer tube 31 and the first channel 43, and then flows out of the spout 4. Conversely, cold water 910 is stopped from being discharged.

With the spacer portion 423 separating the first channel 43 and the second channel 44, it is noted that cold water 910 and hot water 920 are spaced apart by a gap G after being discharged. Although the expansion chamber and the Venturi effect orifice block generate suction for hot water 920 in the second channel 44 when the hot water discharge controller 22 is turned off, cold water 910 still will not be sucked into the second channel 44 as a result of the gap G, keeping cold water 910 away from hot water 920, in a specific case that the cold water discharge controller 21 is turned on right after the hot water discharge controller 22 is turned off. Cold water 910, therefore, will not flow back to the inner tube 32 and the hot water tank along with hot water 920, avoiding the expansion chamber to be filled with water. Accordingly, problem of lowering or losing of suction ability of the expansion chamber is solved.

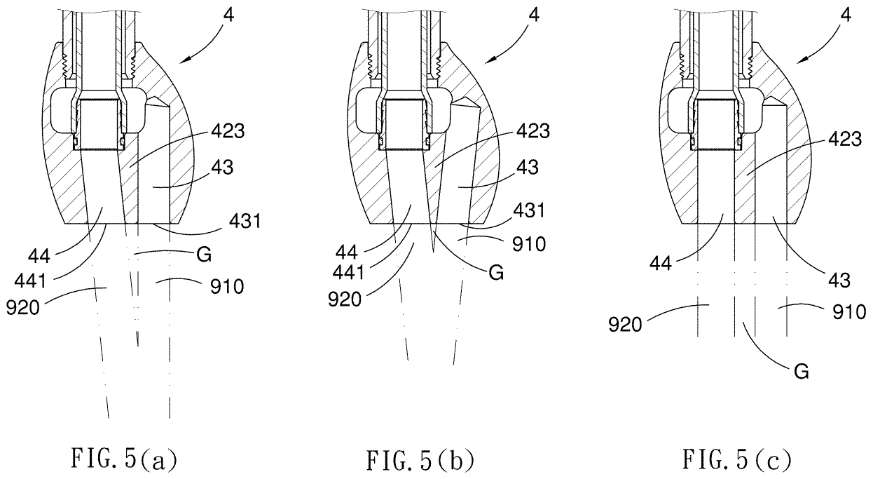

In this embodiment, as shown in FIG. 4, the second channel 44 extends vertically while the first channel 43 extends obliquely with an outlet 431 being closer to the second channel 44. Moreover, various configurations of the first channel and the second channel in the spout are provided. Referring to FIG. 5(a), the first channel 43 extends vertically while the second channel 44 extends obliquely with an outlet 441 being closer to the first channel 43. Referring to FIG. 5(b), the first channel 43 extends obliquely with an outlet 431 being closer to the second channel 44 while the second channel 44 extends obliquely with an outlet 441 being closer to the first channel 43. Referring to FIG. 5(c), both of the first channel 43 and the second channel 44 extend vertically.

With any one of the spout structures above-mentioned, cold water 910 and hot water 920 are always spaced apart by the gap G after being discharged due to the spacer portion 423 so that cold water 910 will not be sucked into the second channel 44.

Referring to FIGS. 3 and 4, a slot 411 and an enlarged space 412 with an inner diameter greater than that of the slot 411 are further provided in the upper portion 41of the spout 4. The slot 411 receives the outer tube outlet 312. In this embodiment, both of the outer tube outlet 312 and the slot 411 have threads 310, 410 so that the outer tube outlet 312 is screwed into the slot 411. But connection between the outer tube outlet 312 and the slot 411 is not limited as thread.

The enlarged space 412 is in communication with the slot 411. On the other hand, the enlarged space 412 is in communication with the first channel 43 via an upper opening 432. The enlarged space 412, accordingly, gathers cold water discharged from the outer tube outlet 312 and discharges through the first channel 43. The inner tube outlet 322 penetrates the enlarged space 412 from top to bottom and connects to an upper groove 442 of the second channel 44 (with a hollow connector 34 described as following) so that the inner tube 32 is positioned in the outer tube 31. An annular passage 30 is formed between the inner tube 32 and the outer tube 31 for water flowing.

As shown in FIG. 2, the hollow connector 34 with a first section 341 and a second section 342 is secured to the inner tube outlet 322. The first section 341 is inserted into and is engaged with the inner tube outlet 322. The second section 342 is inserted into and is engaged with the upper groove 442 of the second channel 44. An O-ring 343 is provided around the second section 342 to be tightly engaged with the second section 342 and the upper groove 442 for sealing. The hollow connector 34 is preferably but not limited to be made of copper or stainless steel.

What is claimed is:

1. A faucet comprising:
a base for introducing hot water and cold water;
an outer tube for cold water to flow through including an outer tube inlet connected to the base and an outer tube outlet in communication with the outer tube inlet;
an inner tube for hot water to flow through disposed within the outer tube, the inner tube including an inner tube inlet connected to the base and an inner tube outlet in communication with the inner tube inlet;
a cold water discharge controller for determining whether cold water flows out of the outer tube and a hot water discharge controller for determining whether hot water flows out of the inner tube, wherein both the cold water discharge controller and the hot water discharge controller are disposed in the base; and
a spout including an upper portion connected to the outer tube outlet and a lower portion extending downward from the upper portion, the lower portion having a first channel that is only in communication with the outer tube, a second channel that is only in communication with the inner tube, and a spacer portion separating the first and second channels.

2. The faucet of claim 1, wherein the upper portion of the spout has a slot receiving the outer tube outlet, the lower portion of the spout has an enlarged space with an inner diameter greater than that of the slot, the enlarged space being in communication with the slot, wherein the enlarged space is connected to an upper opening of the first channel, the inner tube outlet passes through the enlarged space and is connected to an upper groove of the second channel.

3. The faucet of claim 2, wherein a hollow connector and an O-ring are provided at the inner tube outlet, wherein the hollow connector includes a first section and a second section having a greater diameter than the first section, the first section being engaged in the inner tube outlet, the second section being engaged in the upper groove, the O-ring being tightly engaged with the second section and the upper groove.

4. The faucet of claim 1, wherein one of the first and second channels extends vertically, while the other extends obliquely.

5. The faucet of claim 4, wherein the upper portion of the spout has a slot receiving the outer tube outlet, the lower portion of the spout has an enlarged space with an inner diameter greater than that of the slot and is in communication with the slot, wherein the enlarged space is connected to an upper opening of the first channel, the inner tube outlet passes through the enlarged space and is connected to an upper groove of the second channel.

6. The faucet of claim 5, wherein a hollow connector and an O-ring are provided at the inner tube outlet, wherein the hollow connector includes a first section and a second section having a greater diameter than the first section, the first section being engaged in the inner tube outlet, the second section being engaged in the upper groove, the O-ring being tightly engaged with the second section and the upper groove.

7. The faucet of claim 1, wherein both the first and second channels extend obliquely.

8. The faucet of claim 7, wherein the upper portion of the spout has a slot receiving the outer tube outlet, the lower portion of the spout has an enlarged space with an inner diameter greater than that of the slot and is in communication with the slot, wherein the enlarged space is connected to an upper opening of the first channel, the inner tube outlet passes through the enlarged space and is connected to an upper groove of the second channel.

9. The faucet of claim 8, wherein a hollow connector and an O-ring are provided at the inner tube outlet, wherein the hollow connector includes a first section and a second section having a greater diameter than the first section, the first section being engaged in the inner tube outlet, the second section being engaged in the upper groove, the O-ring being tightly engaged with the second section and the upper groove.

10. The faucet of claim 1, wherein both the first and second channels extend vertically.

11. The faucet of claim 10, wherein the upper portion of the spout has a slot receiving the outer tube outlet, the lower portion of the spout has an enlarged space with an inner diameter greater than that of the slot and is in communication with the slot, wherein the enlarged space is connected to an upper opening of the first channel, the inner tube outlet passes through the enlarged space and is connected to an upper groove of the second channel.

12. The faucet of claim 11, wherein a hollow connector and an O-ring are provided at the inner tube outlet, wherein the hollow connector includes a first section and a second section having a greater diameter than the first section, the first section being engaged in the inner tube outlet, the second section being engaged in the upper groove, the O-ring being tightly engaged with the second section and the upper groove.

13. A spout of a faucet comprising:
an upper portion with a slot; and
a lower portion extending downward from the upper portion, the lower portion including a first channel and a second channel that are in communication with the slot, and a spacer portion separating the first and second channels.

14. The spout of claim 13, wherein one of the first and second channels extends vertically, while the other extends obliquely.

15. The spout of claim 14, wherein the lower portion has an enlarged space with an inner diameter greater than that of the slot, the enlarged space being in communication with the slot, wherein the enlarged space is in communication with an upper opening of the first channel, and the enlarged space is in communication with an upper groove of the second channel.

16. The spout of claim 13, wherein both the first and second channels extend obliquely.

17. The spout of claim 16, wherein the lower portion has an enlarged space with an inner diameter greater than that of the slot, the enlarged space being in communication with the slot, wherein the enlarged space is in communication with an upper opening of the first channel, and the enlarged space is in communication with an upper groove of the second channel.

18. The spout of claim 13, wherein both the first and second channels extend vertically.

19. The spout of claim 18, wherein the lower portion has an enlarged space with an inner diameter greater than that of the slot, the enlarged space being in communication with the slot, wherein the enlarged space is in communication with an upper opening of the first channel, and the enlarged space is in communication with an upper groove of the second channel.
